(19) United States
(12) Patent Application Publication
(10) Pub. No.: US 2013/0335432 A1
(43) Pub. Date: Dec. 19, 2013

(54) RENDERING SERVER, CENTRAL SERVER, ENCODING APPARATUS, CONTROL METHOD, ENCODING METHOD, AND RECORDING MEDIUM

(71) Applicant: Square Enix Holdings Co., Ltd., Tokyo (JP)

(72) Inventor: Tetsuji IWASAKI, Quebec (CA)

(73) Assignee: SQUARE ENIX HOLDINGS CO., LTD., Tokyo (JP)

(21) Appl. No.: 13/972,375

(22) Filed: Aug. 21, 2013

Related U.S. Application Data
(63) Continuation of application No. PCT/JP2012/078764, filed on Oct. 31, 2012.
(60) Provisional application No. 61/556,554, filed on Nov. 7, 2011.

(30) Foreign Application Priority Data
Dec. 19, 2011 (JP) 2011-277628

(51) Int. Cl. G06T 9/00

(52) U.S. Cl. CPC G06T 9/00
USPC 345/522

(57) ABSTRACT

After writing, to a memory which is to be inspected, data appended with parity information, an encoding apparatus reads out the data from the memory, and generates encoded data by applying run-length encoding processing to the data. When the encoding apparatus generates the encoded data with reference to a bit sequence of the written data, it detects a bit flipping error by comparing the bit sequence with the appended parity information.

This application is a continuation of International Patent Application No. PCT/JP2012/078764 filed on Oct. 31, 2012, claims priority to U.S. Patent Provisional Application No. 61/556,554, filed Nov. 7, 2011, and Japanese Patent Application No. 2011-277628 filed on Dec. 19, 2011, which are hereby incorporated by reference herein in their entirety.

### BACKGROUND OF THE INVENTION

1. Field of the Invention

The present invention relates to a rendering server, central server, encoding apparatus, control method, encoding method, and recording medium, and particularly to a GPU memory inspection method using video encoding processing.

2. Description of the Related Art

Client devices such as personal computers (PCs) capable of network connection have become widespread. Along with the widespread use of the devices, the network population of the Internet is increasing. Various services using the Internet have recently been developed for the network users, and there are also provided entertainment services such as games.

One of the services for the network users is a multiuser online network game such as MMORPG (Massively Multiplayer Online Role-Playing Game). In the multiuser online network game, a user connects his/her client device in use to a server that provides the game, thereby doing match-up play or team play with another user who uses another client device connected to the server.

In a general multiuser online network game, each client device sends/receives data necessary for game rendering to/from the server. The client device performs rendering processing using the received data necessary for rendering and presents the generated game screen to a display device connected to the client device, thereby providing the game screen to the user. Information the user has input by operating an input interface is sent to the server and used for calculation processing in the server or transmitted to another client device connected to the server.

However, some network games that cause a client device to performs rendering processing require a user to use a PC having sufficient rendering a user a dedicated game machine. For this reason, the number of users of a network game (one content) depends on the performance of the client device required by the content. A high-performance device is expensive, as a matter of course, and the number of users who can own the device is limited. That is, it is difficult to increase the number of users of a game that requires high rendering performance, for example, a game that provides beautiful graphics.

In recent years, however, there are also provided games playable by a user without depending on the processing capability such as rendering performance of a client device. In a game as described in International Publication No. 2009/138878, a server acquires the information of an operation caused in a client device and provides, to the client device, a game screen obtained by performing rendering processing using the information.

The rendering performance of a device which performs the aforementioned rendering processing depends on the processing performance of a GPU included in that device. The monetary introduction cost of a GPU varies depending not only on the processing performance of that GPU but also on the reliability of a GPU memory included in the GPU. That is, when a rendering server renders a screen to be provided to a client device like in International Publication No. 2009/138878, the introduction cost of the rendering server rises with increasing reliability of a memory of a GPU to be adopted. By contrast, a GPU including a GPU memory having low reliability may be used to attain a cost reduction. In this case, error check processing of the GPU memory has to be periodically performs.

However, as described in International Publication No. 2009/138878, when memory check processing of a memory is parallelly performed for a GPU which performs main processing such as rendering processing of a screen to be provided for each frame, this results in an increase in calculation volume, and the quality of services to be provided may be reduced.

### SUMMARY OF THE INVENTION

The present invention has been made in consideration of such conventional problems. The present invention provides a rendering server, central server, encoding apparatus, control method, encoding method, and recording medium, which perform efficient memory inspection using encoding processing.

The present invention in its first aspect provides a rendering server for outputting encoded image data, comprising: a rendering unit which is able to render an image using a GPU; a writing unit which is able to writ3 the image rendered by the rendering unit to a GPU memory included in the GPU; and an encoding unit which is able to read out, from the GPU memory, the image written by the writing unit, and generate the encoded image data by applying run-length encoding processing to the image, wherein the writing unit writes, to the GPU memory, the image with appending parity information to the image; and when the encoding unit generates the encoded image data with reference to a bit sequence of the image read out from the GPU memory, the encoding unit detects a bit flipping error by comparing the bit sequence with the parity information appended by the writing unit.

The present invention in its second aspect provides a central server to which one or more rendering servers are connected, comprising: a detection unit which is able to detect a connection of a client device; an allocation unit which is able to allocate, to any of GPUs included in the one or more rendering servers, generation of encoded image data to be provided to the client device detected by the detection unit; and a transmission unit which is able to receive the encoded image data from the rendering server which includes the GPU allocated to the connected client device by the allocation unit, and transmit the encoded image data to the client device, wherein the allocation unit receives the number of detected bit flipping errors in association with the GPU to which generation of the encoded image data is allocated from the rendering server including that GPU; and when the number of times exceeds a threshold, the allocation unit excludes that GPU from the GPUs to which generation of the encoded image data is allocated.

The present invention in its third aspect provides an encoding apparatus comprising: a writing unit which is able to write, to a memory, data appended with parity information; and an encoding unit which is able to read out, from the memory, the data written by the writing unit, and generate encoded data by applying run-length encoding processing to the data, wherein when the encoding unit generates the encoded data with reference to a bit sequence of the written data, the encoding unit detects a bit flipping error by comparing the bit sequence with the appended parity information.

The present invention in its fourth aspect provides a control method of a rendering server for outputting encoded image data, comprising: a rendering step in which a rendering unit of the rendering server renders an image using a GPU; a writing step in which a writing unit of the rendering server writes the image rendered in the rendering step to a GPU memory included in the GPU; and an encoding step in which an encoding unit of the rendering server reads out, from the GPU memory, the image written in the writing step, and generates the encoded image data by applying run-length encoding processing to the image, wherein in the writing step, the writing unit writes, to the GPU memory, the image with appending parity information to the image; and when the encoding unit generates the encoded image data with reference to a bit sequence of the image read out from the GPU memory in the encoding step, the encoding unit detects a bit flipping error by comparing the bit sequence with the parity information appended in the writing step.

The present invention its fifth aspect provides a control method of central server to which one or more rendering servers are connected, comprising: a detection step in which a detection unit of the central server detects a connection of a client device; an allocation step in which an allocation unit of the central server allocates, to any of GPUs included in the one or more rendering servers, generation of encoded image data to be provided to the client device detected in the detection step; and a transmission step in which a transmission unit of the central server receives the encoded image data from the rendering server which includes the GPU allocated to the connected client device in the allocation step, and transmits the encoded image data to the client device, wherein in the allocation step, the allocation unit receives the number of detected bit flipping errors in association with the GPU to which generation of the encoded image data is allocated from the rendering server including that GPU, and when the number of times exceeds a threshold, the allocation unit excludes that GPU from the GPUs to which generation of the encoded image data is allocated.

The present invention in its sixth aspect provides an encoding method comprising: a writing step in which a writing unit writes, to a memory, data appended with parity information; and an encoding step in which an encoding unit reads out, from the memory, the data written in the write step and generates encoded data by applying run-length encoding processing to the data, wherein in the encoding step, when the encoding unit generates the encoded data with reference to a bit sequence of the written data, the encoding unit detects a bit flipping error by comparing the bit sequence with the appended parity information.

Further features of the present invention will become apparent from the following description of exemplary embodiments (with reference to the attached drawings).

### BRIEF DESCRIPTION OF THE DRAWINGS

FIG. 1 is a view showing the system configuration of a rendering system according to an embodiment of the present invention;

FIG. 2 is a block diagram showing the functional arrangement of a rendering server 100 according to the embodiment of the present invention;

FIG. 3 is a block diagram showing the functional arrangement of a central server 200 according to the embodiment of the present invention;

FIG. 4 is a flowchart exemplifying screen providing processing according to the embodiment of the present invention; and

FIG. 5 is a flowchart exemplifying screen generation processing according to the embodiment of the present invention.

### DESCRIPTION OF THE EMBODIMENTS

Exemplary embodiments of the present invention will be described in detail hereinafter with reference to the drawings. Note that one embodiment to be described hereinafter will explain an example in which the present invention is applied to a central server which can accept connections of one or more client devices, and a rendering server which can concurrently generate screens to be respectively provided to the one or more client devices as an example of a rendering system. However, the present invention is applicable to an arbitrary device and system, which can concurrently generate screens (image data) to be provided to one or more client devices.

Assume that a screen, which is provided to a client device by the central server in this specification, is a game screen generated upon performing game processing. After the rendering server renders a screen for each frame, the screen is provided after it is encoded. However, the present invention is not limited to generation of a game screen. The present invention can be applied to an arbitrary apparatus which provides encoded image data to a client device.

### <Configuration of Rendering System>

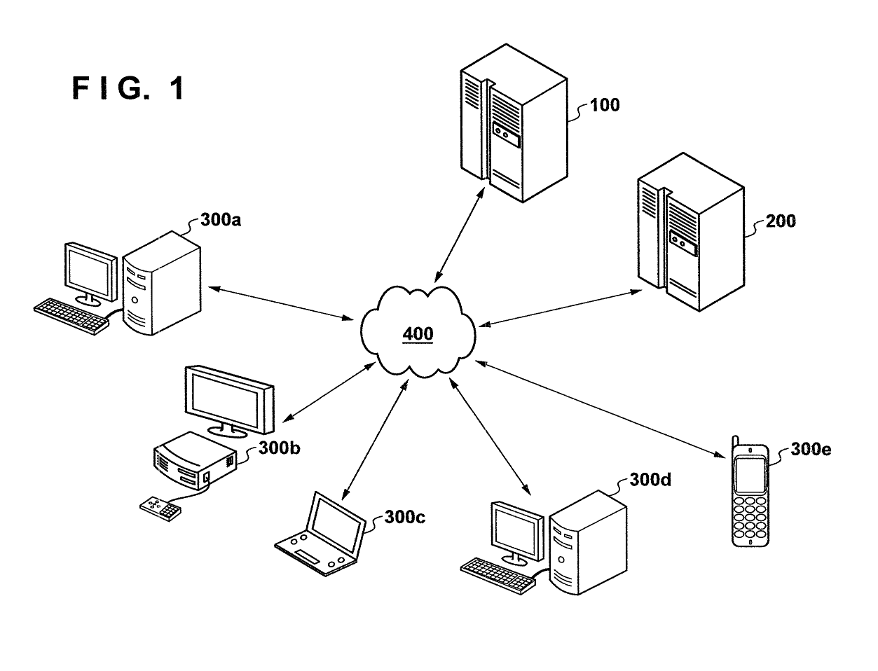

FIG. 1 is a view showing the system configuration of a rendering system according to an embodiment of the present invention.

As shown in FIG. 1, client devices 300a to 300e, which are provided services, and a central server 200, which provides the services, are connected via a network 400 such as the Internet. Likewise, a rendering server 100 which renders screens to be provided to the client devices 300 is connected to the central server 200 via the network 400. Note that in the following description, “client device 300” indicates any one of the client devices 300a to 300e unless otherwise specified.

The client device 300 is not limited to PC, home game machine, and portable game machine, but may be, for example, a device such as mobile phone, PDF, and tablet. In the rendering system of this embodiment, the rendering server 100 generates game screens according to operation inputs made at the client devices, and the central server 200 distributes the generated game screens to the client devices 300. For this reason, the client device 300 need not have any rendering function required to generate a game screen. That is, the client device 300 can be a device, which has a user interface used for making an operation input and a display device which displays a screen, or a device, to which the user interface and the display device can be connected. Furthermore the client device can be a device, which can decode the received game screen and can display the decoded game screen using the display device.

The central server 200 executes and manages a game processing program, issues a rendering processing instruction to the rendering server 100, and performs data communication with the client device 300. More specifically, the central server 200 executes game processing program associated with a game to be provided to the client device 300.

The central server 200 manages, for example, pieces of information such as a position and direction, on a map, of a character operated by a user of each client device, and events to be provided to each character. Then, the central server 200 controls the rendering server 100 to generate a game screen according to the state of the managed character. For example, when information of an operation input, performed by the user on each connected client device, is input to the central server 200 via the network 400, the central server 200 performs processing for reflecting that information to information of the managed character. Then, the central server 200 decides rendering parameters associated with a game screen based on the information of the character to which the operation input information is reflected, and issues a rendering instruction to any of GPUs included in the rendering server 100. Note that the rendering parameters include information of a position and direction of a camera (viewpoint) and rendering objects included in a rendering range.

The rendering server 100 assumes a role of performing rendering processing. The rendering server 100 has four GPUs in this embodiment, as will be described later. The rendering server 100 renders a game screen according to a rendering instruction received from the central server 200, and outputs the generated game screen to the central sever 200. Assume that the rendering server 100 can concurrently generate a plurality of game screens. The rendering server 100 performs rendering processes of game screens using the designated GPUs based on the rendering parameters which are received from the central server 200 in association with the game screens.

The central server 200 distributes the game screen, received from the rendering server 100 according to the transmitted rendering instruction including identification information and detailed information of rendering objects, to the corresponding client device as image data for one frame of encoded video data. In this manner, the rendering system of this embodiment can generate a game screen according to an operation input performed on each client device, and can provide the game screen to the user via the display device of that client device.

Note that the following description will be given under the assumption that the rendering system of this embodiment includes one rendering server 100 and one central server 200. However, the present invention is not limited to such specific embodiment. For example, one rendering server 100 may be allocated to a plurality of central servers 200, or a plurality of rendering servers 100 may be allocated to a plurality of central servers 200.

### <Arrangement of Rendering Server 100>

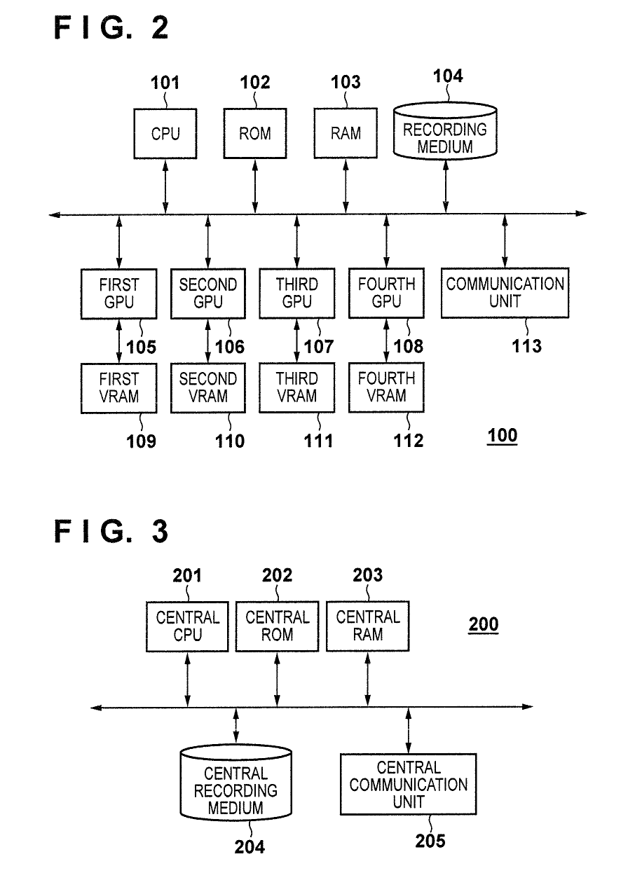

FIG. 2 is a block diagram showing the functional arrangement of the rendering server 100 according to the embodiment of the present invention.

A CPU 101 controls the operations of respective blocks included in the rendering server 100. More specifically, the CPU 101 controls the operations of the respective blocks by reading out an operation program of rendering processing stored in, for example, a ROM 102 or recording medium 104, extracting the readout program onto a RAM 103, and executing the extracted program.

The ROM 102 is, for example, a rewritable nonvolatile memory. The ROM 102 stores other operation programs and information such as constants required for the operations of the respective blocks included in the rendering server 100 in addition to the operation program of the rendering processing.

The RAM 103 is a volatile memory. The RAM 103 is used not only as an extraction area of the operation program, but also as a storage area used for temporarily storing intermediate data and the like, which are output during the operations of the respective blocks included in the rendering server 100.

The recording medium 104 is, for example, a recording device such as an HDD, which is removably connected to the rendering server 100. In this embodiment, assume that the recording medium 104 stores following data used for generating a screen in the rendering processing:
model data
texture data
rendering program
data for calculating used in the rendering program

A communication unit 113 is a communication interface included in the rendering server 100. The communication unit 113 performs data communication with another device connected via the network 400, such as the central server 200. When the rendering server 100 transmits data, the communication unit 113 converts data into a data transmission format specified between itself and the network 400 or a transmission destination device, and transmits data to the transmission destination device. Also, when the rendering server 100 receives data, the communication unit 113 converts data received via the network 400 into an arbitrary data format which can be read by the rendering server 100, and stores the converted data in, for example, the RAM 103.

A first GPU 105, second GPU 106, third GPU 107, and fourth GPU 108 generate game screen to be provided to the client device 300 in the rendering processing. To each GPU, a video memory (first VRAM 109, second VRAM 110, third VRAM 111, and fourth VRAM 112) used as a rendering area of a game screen is connected. Each GPU has a GPU memory as a work area. When each GPU performs rendering on the connected VRAM, it extracts a rendering object onto the GPU memory, and then renders the extracted rendering object onto the corresponding VRAM. Note that the following description of this embodiment will be given under the assumption that one video memory is connected to one GPU. However, the present invention is not limited to such specific embodiment. That is, the arbitrary number of video memories may be connected to each GPU.

### <Arrangement of Central Server 200>

The functional arrangement of the central server 200 of this embodiment will be described below. FIG. 3 is a block diagram showing the functional arrangement of the central server 200 according to the embodiment of the present invention.

A central CPU 201 controls the operations of respective blocks included in the central server 200. More specifically, the central CPU 201 controls the operations of the respective blocks by reading out a program of game processing stored in, for example, a central ROM 202 or central recording medium 204, extracting the readout program onto a central RAM 203, and executing the extracted program.

The central ROM 202 is, for example, a rewritable nonvolatile memory. The central ROM 202 may store other programs in addition to the program of the game processing. Also, the central ROM 202 stores information such as constants required for the operations of the respective blocks included in the central server 200.

The central RAM 203 is a volatile memory. The central RAM 203 is used not only as an extraction area of the program of the game processing, but also as a storage area used for temporarily storing intermediate data and the like, which are output during the operations of the respective blocks included in the central server 200.

The central recording medium 204 is, for example, a recording device such as an HDD, which is detachably connected to the central server 200. In this embodiment, the central recording medium 204 is used as a database which manages users and client devices using a game, a database which manages various kinds of information on the game, which are required to generate game screens to be provided to the connected client devices, and the like.

A central communication unit 205 is a communication interface included in the central server 200. The central communication unit 205 performs data communication with the rendering server 100 or the client device 300 connected via the network 400. Note that the central communication unit 205 converts data formats according to the communication specifications as in the communication unit 113.

### <Screen Providing Processing>

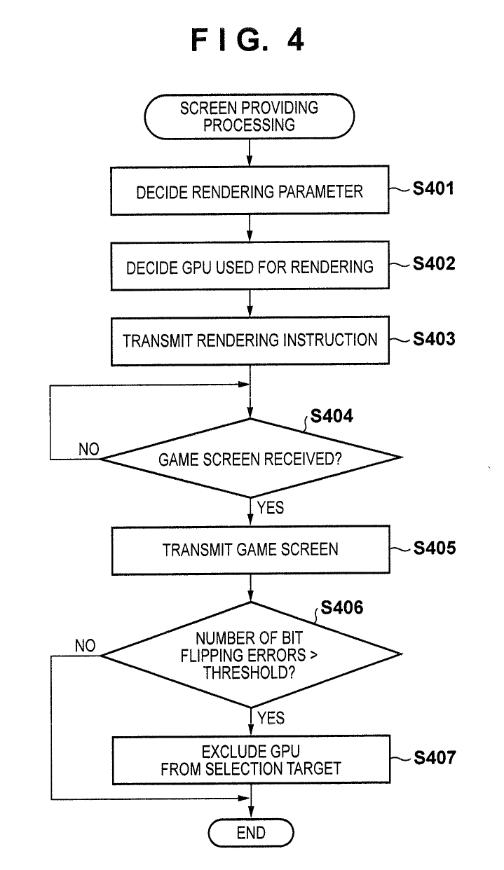

Practical screen providing processing of the central server 200 of this embodiment with the aforementioned arrangement will be described below with reference to the flowchart shown in FIG. 4. The processing corresponding to this flowchart can be implemented when the central CPU 201 reads out a corresponding processing program stored in, for example, the central ROM 202, extracts the readout program onto the central RAM 203, and executes the extracted program.

Note that the following description will be given under the assumption that this screen providing processing is started, for example, when a connection to each client device is complete, and preparation processing required to provide a game to that client device is complete, and is performed for each frame of the game. Also, the following description will be given under the assumption that one client device 300 is connected to the central server 200 for the sake of simplicity. However, the present invention is not limited to such specific embodiment. When a plurality of client devices 300 are connected to the central server 200 as in the aforementioned system configuration, this screen providing processing can be performed for the respective client devices 300.

In step S401, the central CPU 201 performs data reflection processing to decide rendering parameters associated with a game screen to be provided to the connected client device 300. The data reflection processing is that for reflecting an input (a character move instruction, camera move instruction, window display instruction, etc.) performed on the client device, state changes of rendering objects, of which the states are managed by the game processing, and the like, and then specifying the rendering contents of the game screen to be provided to the client device. More specifically, the central CPU 201 receives an input performed on the client device 300 via the central communication unit 205, and updates rendering parameters used in the game screen for the previous frame. On the other hand, the rendering objects, of which the states are managed by the game processing, include characters, which are not targets operated by any users, called NPCs (Non Player Characters), background objects such as a landform, and the like. The states of the rendering objects are changed in accordance with a time elapses or a motion of a user-operation target character. The central CPU 201 updates the rendering parameters for the previous frame in association with the rendering objects, of which the states are managed by the game processing in accordance with an elapsed time and the input performed on the client device upon performing the game processing.

In step S402, the central CPU 201 decides a GPU used for rendering the game screen from those which are included in the rendering server 100 and can perform rendering processing. In this embodiment, the rendering server 100 connected to the central server 200 includes the four GPUs, that is, the first GPU 105, second GPU 106, third GPU 107, and fourth GPU 108. The central CPU 201 decides one of the four GPUs included in the rendering server 100 so as to generate the game screen to be provided to each client device connected to the central server 200. The GPU used for rendering the screen can be decided from GPUs to be selected so as to distribute the load in consideration of, for example, the numbers of rendering objects, the required processing cost, and the like of the game screens corresponding to rendering requests which are concurrently issued. Note that the GPUs to be selected in this step change according to a memory inspection result in the rendering server 100, as will be described later.

In step S403, the central CPU 201 transmits a rendering instruction to the GPU which is decided in step S402 and is used for rendering the game screen. More specifically, the central CPU 201 transfers the rendering parameters associated with the game screen for the current frame, which have been updated by the game processing in step S401, to the central communication unit 205 in association with a rendering instruction, and controls the central communication unit 205 to transmit them to the rendering server 100. Assume that the rendering instruction includes information indicating the GPU used for rendering the game screen, and identification information of the client device 300 to which the game screen is to be provided.

The central CPU 201 determines in step S404 whether or not the game screen to be provided to the connected client device 300 is received from the rendering server 100. More specifically, the central CPU 201 checks whether or not the central communication unit 205 receives data of the game screen having the identification information of the client device 300 to which the game screen is to be provided. Assume that in this embodiment, the game screen to be provided to the client device 300 is encoded image data corresponding to one frame of encoded video data in consideration of a traffic reduction since it is transmitted to the client device 300 for each frame of the game. When the central communication unit 205 receives data from the rendering server 100, the central CPU 201 checks with reference to header information of that information whether or not the data is encoded image data corresponding to the game screen to be provided to the connected client device 300. If the central CPU 201 determines that the game screen to be provided to the connected client device 300 is received, the central CPU 201 proceeds the process to step S405; otherwise, the central CPU 201 repeats the process of this step.

In step S405, the central CPU 201 transmits the received game screen to the connected client device 300. More specifically, the central CPU 201 transfers the received game screen to the central communication unit 205, and controls the central communication unit 205 to transmit it to the connected client device 300.

The central CPU 201 determines in step S406 whether or not the number of times of detection of bit flipping errors of the GPU memory, for any of the first GPU 105, second GPU 106, third GPU 107, and fourth GPU 108, exceeds a threshold. In this embodiment, as will be described later in screen generation processing, when a bit flipping error has occurred in the GPU memory of each GPU, the CPU 101 of the rendering server 100 notifies the central server 200 of information of the number of bit flipping errors in association with identification information of the GPU which has caused that error. For this reason, the central CPU 201 determines in this step first whether or not the central communication unit 205 receives the information of the number of bit flipping errors from the rendering server 100. If it is determined that the information of the number of bit flipping errors is received, the central CPU 201 further checks whether or not the number of bit flipping errors exceeds the threshold. Assume that the threshold is a value, which is set in advance as a value required to determine if the reliability of the GPU memory drops, and is stored in, for example, the central ROM 202. If the central CPU 201 determines that the number of times of detection of bit flipping errors of the GPU memory exceeds the threshold in any of the GPUs included in the rendering server 100, the central CPU 201 proceeds the process to step S407; otherwise, the central CPU 201 finishes this screen providing processing.

In step S407, the central CPU 201 excludes the GPU, of which the number of bit flipping errors exceeds the threshold, from selection targets to which rendering processing of the game screen for the next frame is to be allocated. More specifically, the central CPU 201 stores, in the central ROM 202, logical information indicating that the GPU is excluded from selection targets to which rendering is to be allocated in association with identification information of that GPU. This information is referred to when the GPU to which rendering of the game screen is allocated is selected in step S402.

Note that the following description of this embodiment will be given under the assumption that the central CPU 201 judges the reliability of the GPU memory by checking whether or not the number of bit flipping errors exceeds the threshold. However, the present invention is not limited to such specific embodiment. The central CPU 201 may acquire information of the memory address distribution in which bit flipping errors have occurred, and may evaluate the reliability of the GPU memory according to the number of bit flipping errors within a predetermined address range.

### <Screen Generation Processing>

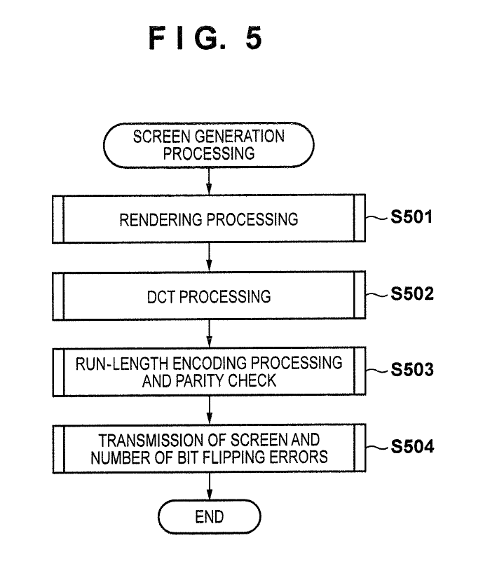

Screen generation processing for generating the game screen (encoded image data) to be provided to the client device in the rendering server 100 according to this embodiment will be described in detail below with reference to the flowchart shown in FIG. 5. The processing corresponding to this flowchart can be implemented when the CPU 101 reads out a corresponding processing program stored in, for example, the ROM 102, extracts the readout program onto the RAM 103, and executes the extracted program. Note that the following description will be given under the assumption that this screen generation processing is started, for example, when the CPU 101 judges that the communication unit 113 receives the rendering instruction of the game screen from the central server 200.

In step S501, the CPU 101 renders the game screen based on the received rendering parameters associated with the game screen. More specifically, the CPU 101 stores the rendering instruction received by the communication unit 113, and the rendering parameters, which are associated with the rendering instruction and related to the game screen for the current frame, in the RAM 103. Then, the CPU 101 refers to the information which is included in the rendering instruction and indicates the GPU used for rendering the game screen, and controls the GPU (target GPU) specified by that information to render the game screen corresponding to the rendering parameter on the VRAM connected to the target GPU.

In step S502, the CPU 101 controls the target GPU to perform DCT (Discrete Cosine Transform) processing for the game screen rendered on the VRAM in step S501. More specifically, the target GPU divides the game screen into blocks each having the predetermined number of pixels, and performs the DCT processing for respective blocks, whereby the blocks are converted into data of a frequency domain. The game screen converted onto the frequency domain is quantized by the target GPU, and is written in the GPU memory of the target GPU. At this time, assume that the target GPU writes the quantized data in the GPU memory while appending a parity bit (parity information) to each bit sequence of a predetermined data length. Note that the following description of this embodiment will be given under the assumption that the DCT processing is directly performed for the game screen. However, as described above, since the game screen is data corresponding to one frame of encoded video data, the DCT processing may be performed for image data generated from the game screen. For example, when a video encoding format is an MPEG format, the target GPU may generate a difference image between image data generated from the game screen for the previous frame by motion-compensating precision and the game screen generated for the current frame, and may perform the DCT processing for that difference image.

In step S503, the CPU 101 performs run-length encoding processing for the game screen (quantized game screen) converted onto the frequency domain to generate data of the game screen to be finally provided to the client device. At this time, in order to perform run-length encoding, the CPU 101 reads out the quantized game screen from the GPU memory of the target GPU, and stores it in the RAM 103. When a bit flipping error has occurred in the GPU memory, an inconsistency is occurred between the screen data and the parity information in the quantized game screen stored in the RAM 103.

On the other hand, the run-length encoding processing is that for attaining data compression by checking a run-length of the same values in a bit sequence of continuous data. That is, when the run-length encoding processing is applied to the quantized game screen stored in the RAM 103, the CPU 101 can grasp, for example, the number of “1”s in a data sequence between parity bits since it refers to all values included in the predetermined number of bit sequences. That is, in the present invention, the CPU 101 attains parity check processing using checking of an arrangement in the bit sequence in the run-length encoding.

In this step, the CPU 101 generates encoded data of the game screen to be finally provided by performing the run-length encoding processing, as described above, and performing the parity check processing to detect occurrence of bit flipping errors in association with the GPU memory of the target GPU. Note that the CPU 101 counts the number of times of detection of bit flipping errors in association with the GPU memory of the target GPU.

In step S504, the CPU 101 transfers the encoded data of the game screen to be finally provided, which is generated in step S503, and information indicating number of times of detection of bit flipping errors in association with the GPU memory of the target GPU to the communication unit 113, and controls the communication unit 113 to transmit them to the central server 200. Assume that at this time, the encoded data of the game screen to be finally provided is transmitted in association with the identification information of the client device 300 which is included in the rendering instruction, and to which the game screen is to be provided. Also, assume that the information indicating the number of times of detection of bit flipping errors is transmitted in association with identification information of the GPU which is included in the rendering instruction and is used for rendering the game screen.

In this manner, occurrence of a bit flipping error can be detected using the encoding processing without executing any dedicated check program in association with the GPU memory. Note that in the above description of this embodiment, the quantized game screen appended with parity information is written in the GPU memory. However, data to be written in the GPU memory is not limited to this. That is, in the error check processing of the GPU memory in the present invention, data immediately before applying the run-length encoding need only be written in the GPU memory while being appended with parity information. That is, the present invention is applicable to aspects in which data is applied to pre-processing of the run-length encoding, the applied data is written in the GPU memory while being appended with parity information, and the run-length encoding is performed by reading out that data.

Note that this embodiment has exemplified the GPU memory. However, the present invention is not limited to the GPU memory, and is applicable to general memories as their error check method.

This embodiment has exemplified the rendering server including a plurality of GPUs. However, the present invention is not limited to such specific arrangement. For example, when a plurality of rendering servers each having one GPU are connected to the central server, the central server may exclude a rendering server having a GPU corresponding to the number of bit flipping errors which exceeds the threshold from those used for rendering the game screen. Alternatively, the client device 300 may be directly connected to the rendering server 100 without arranging any central server. In this case, the CPU 101 may check whether or not the number of bit flipping errors exceeds the threshold, and may exclude the GPU which exceeds the threshold from allocation targets of the GPUs used for rendering the game screen.

Note that in the description of the aforementioned embodiment, when the number of bit flipping errors of the GPU memory exceeds the threshold, rendering of the game screen for the next frame is not allocated to the GPU having that GPU memory. However, the GPU exclusion method is not limited to this. For example, the number of times, which the number of bit flipping errors exceeds the threshold, may be further counted, and when the number of times becomes not less than a predetermined value, that GPU may be excluded. Alternatively, during a server maintenance time period, the GPU corresponding to the number of bit flipping errors which exceeds the threshold may be excluded.

As described above, the encoding apparatus of this embodiment can perform efficient memory inspection by leveraging the encoding processing. More specifically, the encoding apparatus writes data appended with parity information in a memory to be inspected, then reads out the data from the memory. The encoding apparatus then generates encoded data by performing the run-length encoding processing for the data. When the encoding apparatus generates encoded data with reference to each bit sequence in association with written data, it compares that bit sequence with the appended parity information, thereby a bit flipping error of the memory is detected.

In this manner, since the reliability of the memory can be checked at the same time upon performing the run-length encoding processing, a memory having poor reliability can be detected without scheduling a dedicated check program. Also, in the rendering system of the aforementioned embodiment, efficiently automated fault-tolerance can be implemented.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A rendering server for outputting encoded image data, comprising:
a renderer which is able to render an image using a graphics processor;
a writer which is able to write the image rendered by said renderer to a graphics processor memory included in the graphics processor; and
an encoder which is able to read, from the graphics processor memory, the image written by said writer, and generate the encoded image data by applying run-length encoding processing to the image,
wherein said writer writes, to the graphics processor memory, the image with appending parity information to the image; and
when said encoder generates the encoded image data with reference to a bit sequence of the image read from the graphics processor memory, said encoder detects a bit flipping error by comparing the bit sequence with the parity information appended by said writer.

2. The rendering server according to claim 1, wherein said writer writes, to the graphics processor memory, the image rendered by said renderer with applying encoding pre-processing to the image.

3. The rendering server according to claim 2, wherein the encoding pre-processing includes discrete cosine transform processing.

4. The rendering server according to claim 1, wherein the encoded image data is data corresponding to one frame of encoded video data.

5. The rendering server according to claim 1, further comprising:
a counter which is able to count a number of bit flipping errors which are detected by said encoder; and
a notifier which is able to notify an external apparatus of the number of bit flipping errors counted by said counter in association with information indicating a graphics processor in which the bit flipping errors are detected.

6. A central server to which at least one rendering server according to claim 5 is connected, the central server comprising:
a detector which is able to detect a connection of a client device;
an allocator which is able to allocate, to the graphics processor included in any of the at least one rendering server, generation of encoded image data to be provided to the client device detected by said detector; and
a transmitter which is able to receive the encoded image data from the rendering server which includes the graphics processor allocated to the client device by said allocator, and transmit the encoded image data to the client device,
wherein said allocator receives the number of bit flipping errors in association with the graphics processor to which generation of the encoded image data is allocated from the rendering server including that graphics processor; and
when the number of bit flipping errors exceeds a threshold, said allocator excludes that graphics processor from graphics processors to which generation of the encoded image data is allocated.

7. An encoding apparatus comprising:
a writer which is able to write, to a memory, data appended with parity information; and
an encoder which is able to read, from the memory, the data written by said writer, and generate encoded data by applying run-length encoding processing to the data,
wherein when said encoder generates the encoded data with reference to a bit sequence of the data written by said writer, said encoder detects a bit flipping error by comparing the bit sequence with the parity information appended by said writer.

8. A control method of a rendering server for outputting encoded image data, comprising:
rendering, by a renderer of the rendering server, an image using a graphics processor;
writing, by a writer of the rendering server, the image rendered in the rendering to a graphics processor memory included in the graphics processor; and
reading, by an encoder of the rendering server, from the graphics processor memory, the image written in the writing, and generating the encoded image data by applying run-length encoding processing to the image,
wherein in the writing, the writer writes, to the graphics processor memory, the image with appending parity information to the image; and
when the encoder generates the encoded image data with reference to a bit sequence of the image read from the graphics processor memory in the reading and the generating, the encoder detects a bit flipping error by comparing the bit sequence with the parity information appended in the writing.

9. A control method of a central server to which at least one rendering server according to claim 5 is connected, comprising:
detecting, by a detector of the central server, a connection of a client device;
allocating, by an allocator of the central server, to the graphics processors included in any of the at least one rendering server, generation of encoded image data to be provided to the client device detected in the detecting; and
receiving, by a transmitter of the central server, the encoded image data from the rendering server which includes the graphics processor allocated to the client device in the allocating, and transmitting the encoded image data to the client device,
wherein in the allocating, the allocator receives the number of bit flipping errors in association with the graphics processor to which generation of the encoded image data is allocated from the rendering server including that graphics processor, and when the number of bit flipping errors exceeds a threshold, the allocator excludes that graphics processor from graphics processors to which generation of the encoded image data is allocated.

10. An encoding method, comprising:
writing, by a writer, to a memory, data appended with parity information; and
reading, by an encoder, from the memory, the data written in the writing and generating encoded data by applying run-length encoding processing to the data,
wherein in the encoding and the generating, when the encoder generates the encoded data with reference to a bit sequence of the data written by the writer, the encoder detects a bit flipping error by comparing the bit sequence with the parity information appended by the writer.

11. A non-transitory computer-readable recording medium recording a program for controlling a computer to function as the rendering server of claim 1.

12. A non-transitory computer-readable recording medium recording a program for controlling a computer to function as the central server of claim 6.

13. A non-transitory computer-readable recording medium recording a program for controlling a computer to function as the encoding apparatus of claim 7.
